(19) United States
(12) Patent Application Publication
(10) Pub. No.: US 2006/0012595 A1
(43) Pub. Date: Jan. 19, 2006

(54) Driving circuit and driving process of display system

(76) Inventors: Chien-Chih Chen, Jhudong Township (TW); Jian-Shen Yu, Hsinchu City (TW)

Correspondence Address: David I. Roche;BAKER & McKENZIE, 130 E. Randolph Drive, Chicago, IL, 60601, US

(21) Appl. No.: 10/894,289

(22) Filed: Jul. 19, 2004

(51) Int. Cl. G09G 5/00; G09G 5/10

(52) U.S. Cl. 345/207; 345/690

(57) ABSTRACT

A display system comprises a scan driver circuit coupled with the scan lines, and a data driver circuit coupled through a plurality of switching units with the data lines, wherein the number of data lines connected to each switching unit at least is more than 3. Each data line is coupled with pixels of at least two different colors. In a driving process, scan signals are delivered through the scan lines to select rows of pixels. The data driver circuit is configured to deliver data signals through the data lines for charging the data signals in the pixels by sequential operations of the switching units.

### BACKGROUND OF THE INVENTION

1. Field of the Invention

This invention relates to the field of display technology, and more particularly to a driving circuit for display system that can improve the image quality and reduces the power consumption of the display system.

2. Description of the Related Art

FIG. 1A is a schematic view of a conventional liquid crystal display (LCD) panel. The conventional LCD panel 100 includes an area 108 of pixel array driven by means of a scan driver circuit 120 and a data driver circuit 140. An application specific integrated circuit (ASIC) 110 issues timing control signals 112 to control the operation of the scan, data driver circuits 120, 140.

FIG. 1B is a schematic view showing in more details a pixel array circuitry known in the art. The panel construction includes a mesh of scan and data lines 102, 104 that defines an array of pixels 106. In a multicolor display, the pixels 106 can include red pixels (R), green pixels (G) and blue pixels (B). The scan driver circuit 120 couples with the scan lines 102, while the data driver circuit 140 couples via switching units 130 with the data lines 104. The scan driver circuit 120 issues scan signals via the scan lines 102 to select rows of pixels. The data driver circuit 140 issues data signals to the pixels 106 via turning on the switching units 130.

Conventionally, the switching units 130 receive three data lines 104 through which are delivered analog data signals. Each data line 104 couples with pixels of a same color, and each switching unit 130 conventionally couples with three data lines 104. Each data line 104 couples with pixels of red, green and blue color, respectively.

In operation, a scan signal is delivered on one scan line 102 for a selection time period to select one row of pixels 106. The data driver circuit 140 delivers sets of analog data signals configured to achieve specific display outputs of the color pixels 106. The analog data signals are delivered to the data lines 104 through signal bus lines 142 which are in a number equal to the number of data lines 104 coupled with each switching unit 130, in other words 3 bus lines each corresponding to one of the three pixel colors R, G, B.

The switching units 130 are sequentially turned on to deliver and charge the analog data signals to the color pixels 106. Because the analog data signals delivered through each switching unit 130 are usually sustained for a short time of the selection time period, a high-speed operational amplifier (not shown) is conventionally installed to effectively charge the pixels. Unfortunately, this design increases the power consumption, which is particularly undesirable in portable electronic appliances such as digital cameras, “personal digital assistants” (commonly known as PDA), or the like.

Therefore, a need exists for improvements of the conventional display system, and in particular for a display system that can operate with lower power consumption.

### SUMMARY OF THE INVENTION

The application describes a display system and a process of driving the display system. The display system includes an array of pixels respectively coupled with scan and data lines.

In one embodiment, the display system comprises a mesh of scan and data lines defining an array of pixels in delta arrangement, a scan driver circuit coupled with the scan lines, and a data driver circuit coupled through a plurality of switching units with the data lines, wherein the number of data lines connected to each switching unit at least is more than 3. The scan driver circuit is configured to deliver scan signals through the scan lines to select rows of pixels. The data driver circuit is configured to deliver data signals through the data lines for charging the data signals in the pixels by selective operation of the switching units.

In one embodiment, the process of driving a display system comprises sequentially issuing scan signals on the scan lines, wherein each scan signal is issued on one scan line for a selection time period to select one corresponding row of pixels, and delivering data signals through each set of data lines over one selection time period to charge the corresponding pixels for display outputs, wherein each set of data lines includes more than 3 data lines.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1A is a schematic view of a conventional LCD panel construction;

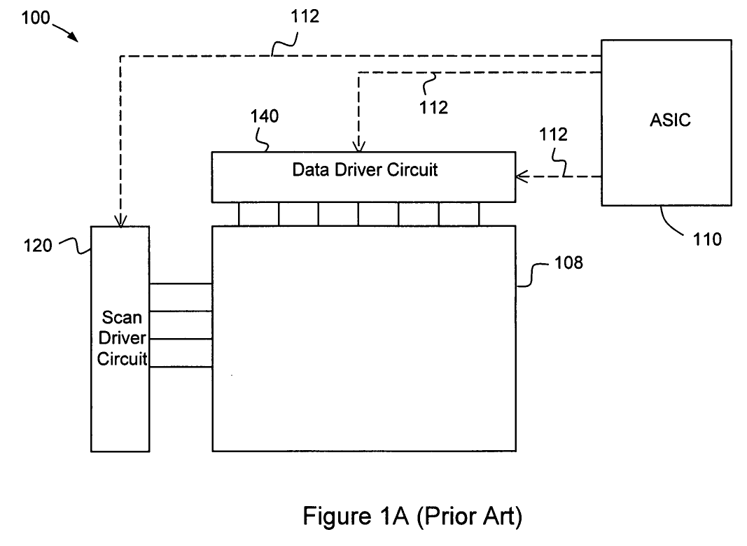

FIG. 1B is a schematic view of a conventional pixel array construction;

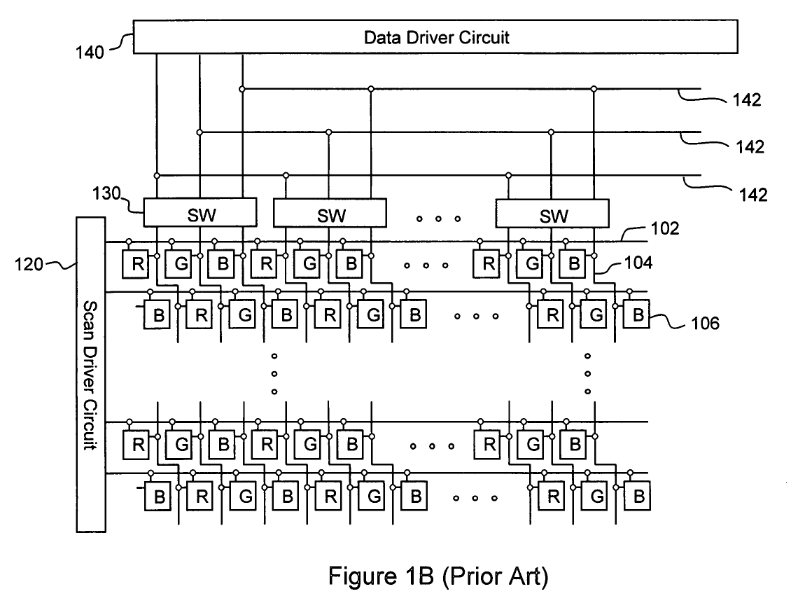

FIG. 2A is a schematic view of a pixel array circuit implemented in a multicolor display system according to an embodiment of the invention; and

FIG. 2B is a flowchart of a driving process implemented in a display system according to an embodiment of the invention.

### DESCRIPTION OF THE DETAILED EMBODIMENT(S)

The application describes a display system and a process of driving the display system. The display system generally can be of any types, such as a LCD system, a plasma display system, or an electroluminescent display.

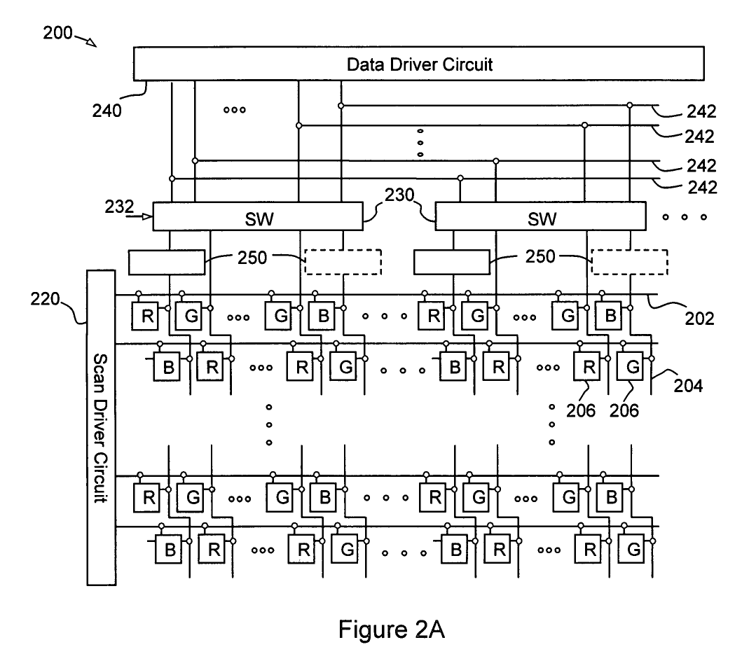

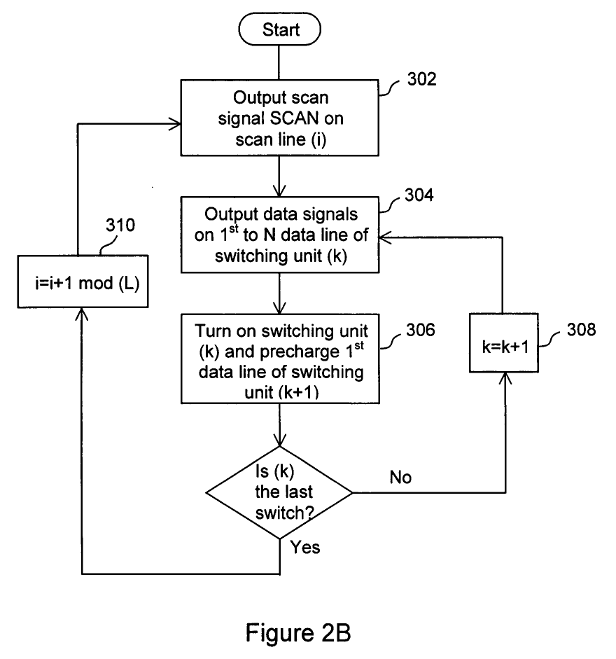

FIG. 2A is a schematic view of a pixel array circuit implemented in a multicolor display according to an embodiment of the invention. The pixel array circuit 200 includes a mesh of scan, data lines 202, 204 that defines an array of color pixels 206. The color pixels 206 can include red (R), green (G) and blue (B) color pixels. According to the type of display implemented, the pixel cell can be constructed with different structures based on the operation of a liquid crystal material, a plasma gas or electroluminescent material. The scan lines 202 couple with a scan driver circuit 220, while the data lines 204 couple via switching units 230 with a data driver circuit 240.

The scan driver circuit 220 issues addressing signals on the scan lines 202 to select one or more rows of color pixels 206. Meanwhile, the data driver circuit 240 issues image data signals in the form of analog signals through signal bus 242 to the data lines 204. Each data line 204 is coupled with pixels of at least two colors. The color pixels 206 further can be placed according to a delta arrangement.

Each of the switching unit 230 connects with a number of data lines 204 and further receives a timing control signal 232 configured to command the operation of the switching unit 230. One switching unit 230 can include a plurality of individual switch devices respectively connected to one data line. The switching units 230 can be operable in any sequential order. The number of data lines 204 coupled with each switching unit 230 is greater than 3, and can be set as a multiple of 3. In an embodiment, each switching unit 230 can exemplary receive 6 data lines 204. Since the number of data lines coupled with one switching unit 230 is increased, less switching operations are required and the pixel charging time can be advantageously prolonged, as described hereafter.

Additionally, precharging circuits 250 can be coupled with one outmost data line 204 of each switching unit 230. In an embodiment in which one switching unit 230 includes a number N of data lines 204, the precharging circuit 250 therefore can be coupled with either the 1^{st} or N^{th} data line 204 of each switching unit 230. In an example where 6 data lines connect with each switching unit 230, a precharging circuit 250 thus can be coupled with either the first or sixth data line 204. Coupling of the precharging circuit 250 with either the first or last data line 204 is determined according to the direction of pixel data charging (i.e. from left to right or reciprocally) in the driving process.

FIG. 2B is a flowchart of exemplary steps performed in a driving process of a display system according to an embodiment of the invention. For purposes of illustration, in the present example, various steps are described in a particular order; however, when supported by accompanying driving schemes, these steps can be performed in any order, serially or in parallel. In the following description, a left-to-right direction is exemplary implemented for pixel data charging along each row of pixels.

First, a scan signal SCAN is outputted on a scan line (i) (302) for a row selection time period t. Meanwhile, data signals DATA are delivered through the 1^{st} to N^{th} data lines of a switching unit (k) to charge the corresponding pixels (304). The switching unit (k) then is turned on to charge the pixels associated with the 1^{st} to N^{th} data lines of the switching unit (k), while the 1^{st} data line of the switching unit (k+1) is precharged by a precharging circuit (306). If the number of switching units totally is M, the charging time for data lines coupled with a same switching unit is (t/M). The foregoing driving scheme is repeated over the selection time period t for the successive switching units until pixel charging is achieved through all the data lines (308). The similar selection and pixel charging processes apply to all successive rows of pixels associated with the scan lines in a number of L lines (310).

Each row of pixels is configured to maintain display outputs corresponding to the charged data signals DATA until it is cyclically addressed again according to the foregoing driving scheme. Sustaining the display outputs in each pixel can be achieved via the mount of a storage capacitor that stores the data signals received from the data lines (not shown).

Pixel precharging through the 1^{st} data line of the switching unit (k+1) can prevent undesirable coupling between the N^{th} data line of the switching unit (k) and the 1^{st} data line of the switching unit (k+1) when the N data lines of the switching unit (k+1) undergo charging. Additionally, reducing the number of switching units allows to allocate a longer charging time to properly charge the pixels associated with each set of data lines 1˜N, and no high-frequency devices are needed. As a result, the image quality of the display system is improved, and its power consumption is reduced.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Additionally, structures and functionality presented as discrete components in the exemplary configurations may be implemented as a combined structure or component. These and other variations, modifications, additions, and improvements may fall within the scope of the invention as defined in the claims that follow.

What is claimed is:

1. A display system, comprising:
a mesh of scan and data lines defining an array of pixels, wherein the pixels are distributed in a delta arrangement;
a scan driver circuit coupled with the scan lines, wherein the scan driver circuit is configured to deliver scan signals through the scan lines to select rows of pixels; and
a data driver circuit coupled through a plurality of switching units with the data lines, wherein the data driver circuit is configured to deliver data signals through the data lines for charging the data signals in the pixels by selective operation of the switching units, and the number of data lines connected to each switching unit at least is more than 3.

2. The display system according to claim 1, wherein the array of pixels includes pixels of different colors.

3. The display system according to claim 1, wherein each data line is coupled with pixels of at least two different colors.

4. The display system according to claim 1, further comprising at least one precharging circuit configured to precharge through one data line while data signal charging is performed through one neighboring data line.

5. The display system according to claim 4, wherein the at least one precharging circuit is coupled with an outmost data line of one switching unit.

6. The display system according to claim 1, wherein the number of data lines coupled with one switching unit is a multiple of 3.

7. The display system according to claim 1, wherein the number of data lines coupled with one switching unit is at least 6.

8. A process of driving a display system including an array of pixels respectively coupled with scan and data lines, wherein the pixels are distributed in a delta arrangement and the data lines are grouped into sets of data lines, the process comprising:
sequentially issuing scan signals on the scan lines, wherein each scan signal is issued on one scan line for a selection time period to select the corresponding row of pixels; and
delivering data signals through each set of data lines over one selection time period to charge the corresponding pixels for display outputs, wherein each set of data lines includes more than 3 data lines.

9. The process according to claim 8, wherein delivering data signals through each set of data lines to charge the corresponding pixels for display outputs over one selection time period includes turning on switching units respectively connected to each set of data lines.

10. The process according to claim 8, wherein delivering data signals through each set of data lines is performed sequentially.

11. The process according to claim 8, wherein delivering data signals through each set of data lines includes delivering data signals through successive sets of data lines in a pixel row direction.

12. The process according to claim 8, wherein each set of data lines includes a number of data lines multiple of 3.

13. The process according to claim 8, wherein each set of data lines includes at least 6 data lines.

14. The process according to claim 8, wherein delivering data signals through each set of data lines over one selection time period to charge the corresponding pixels for display outputs further comprises:
delivering data signals to one set of data lines; and
precharging one outmost data line of a next set of data lines which is adjacent to the set of data lines being currently charged with the data signals.

15. The process according to claim 8, wherein each data line is coupled with pixels of at least two different colors.
